(19) United States
(12) Patent Application Publication
(10) Pub. No.: US 2026/0284712 A1
(43) Pub. Date: Sep. 24, 2026

(54) Assembly for Cleaning a Grill Grate

(71) Applicant: Eriver AG, Stansstad (CH)

(72) Inventor: Joel Niederberger, Oberdorf NW (CH)

(21) Appl. No.: 19/111,330

(22) PCT Filed: Sep. 6, 2023
(86) PCT No.: PCT/EP2023/074512

§ 371 Date: Feb. 10, 2026

(30) Foreign Application Priority Data
Sep. 13, 2022 (DE) 10 2022 123 387.1

(51) Int. Cl. B08B 3/02

(52) U.S. Cl. CPC B08B 3/024; B08B 2203/0264

(57) ABSTRACT

A device for reliably, quickly, and easily cleaning a grill grate. The device includes a holder for the grill grate and a high-pressure water cleaning device with at least one spray nozzle. The grill grate can be arranged vertically, at an incline, or horizontally, and at least the holder for the grill grate and the high-pressure water cleaning device are surrounded by a housing.

The invention relates to a device for cleaning a grill grate or a cooking surface or baking surface or an intermediate layer for cooking or baking or for a raclette, wherein residues that arise or remain during grilling, cooking, baking, or raclette from the grilled food or during raclette, cooking, or baking are intended to be removed automatically and reliably. In this context, the term “grill grate” is understood broadly, so that sheet-like arrangements with openings or apertures or a surface structure, as well as plates made of metal, stone, or other materials and constructions suitable for grilling, baking, cooking, or for a raclette, are likewise included.

The object of the invention is to provide a device for cleaning a grill grate that can be cleaned reliably, quickly, and easily.

With the invention, in the stated application case, it is achieved that a device for cleaning a grill grate is provided, wherein the device comprises a holder for the grill grate and a high-pressure water cleaning device with at least one spray nozzle, wherein the grill grate can be arranged vertically, at an angle, or horizontally, and wherein at least the holder for the grill grate and the high-pressure water cleaning device are surrounded by a housing.

Advantageously, any grill grates can be cleaned reliably, thoroughly, and also very conveniently or easily for the user by means of the device. Furthermore, environmentally friendly criteria can also be taken into account and implemented with the device according to the invention for cleaning a grill grate, since the device according to the invention provides high-pressure water cleaning, whereas previously the cleaning of greasy grill grates has taken place directly or regularly with a considerable use of cleaning agents or solvents into or in the environment.

For example, the high-pressure water cleaning device provides a pressure of 1000 bar. Other pressures of 500 bar or 800 bar as well as 1200 bar are also conceivable.

Advantageous designs of the invention are presented in the sub-claims.

By advantageously providing the holder with a shelf, shelf areas, a shaft, or at least a support surface, the grill grate can be arranged reliably and in a positionally stable manner for cleaning.

Alternatively or additionally, the grill grate can be slid into, inserted into, or placed into the holder, so that the grill grate is arranged reliably and in a positionally stable manner for cleaning, without moving or shifting.

Wherein the holder holds and clamps the grill grate at at least one edge and/or at at least one edge region, comprehensive and approximately planar cleaning of the grill grate is promoted in one cleaning pass, wherein, if applicable, no further or only a few areas need to be subjected to at least one further cleaning pass.

Wherein the holder holds and clamps the grill grate at at least two opposite end faces or outer edge surfaces, comprehensive and approximately planar cleaning of the grill grate is promoted in at least one cleaning pass. In addition, if necessary, the number of cleaning passes can be limited to two cleaning passes by selectively repositioning the grill grate.

Wherein the holder acts on the grill grate from one side or from opposite sides surfaces or edges or holds and clamps the grill grate, thereby facilitating comprehensive and substantially planar cleaning of the grill grate as well as a reliable position during cleaning.

By arranging the holder parallel and/or transverse to the grill grate and/or the grill grate displaceable or movable with the holder, comprehensive and approximately planar cleaning of the grill grate as well as a simple construction of the high-pressure water cleaning device is promoted.

Because the holder comprises pressure elements or retaining elements that can be pressurized with air or liquid, it can be flexibly adapted to different grill grates and different grill grates.

Wherein the holder has a region with a longitudinal extension and/or a hose-shaped region, wherein the region with the longitudinal extension and/or the hose-shaped region is arranged vertically or horizontally, the area of contact or coverage of the holder on the grill grate can be reduced and thus cleaning per cleaning pass can be promoted.

Wherein at least the hose-shaped region has a protective covering at least in certain regions, the durability of the hose-shaped region of the holder is promoted. In addition, complex and expensive materials for the hose-shaped region of the holder can be dispensed with.

Furthermore, the protective covering can also have a surface shape or surface structure that deflects, shapes, or guides the water jet, so that a water jet striking the protective covering is nevertheless usable and effective on the grill grate by being deflected or guided.

Wherein the holder is pivotable, reversible, or rotatable, the grill grate can be brought more easily and automatically into a favorable position for comprehensive or complete or two-sided cleaning, or selectively to or in front of the high-pressure water cleaning device.

Wherein the holder comprises plate-shaped, cup-shaped, or suction-cup-shaped holding elements and/or at least one holding arm, reliable clamping or holding of the grill grate during cleaning is promoted.

Wherein the high-pressure water cleaning device is movable horizontally and/or vertically and/or over at least one region of the planar extent of the grill grate, the grill grate can be comprehensively reached by the high-pressure water cleaning device, thereby promoting cleaning. In addition, the holder for the grill grate can be simplified.

Wherein the high-pressure water cleaning device is arranged on one side or on both sides of the grill grate, and wherein the high-pressure water cleaning device acts on or is oriented toward the grill grate on one side or on both sides, the grill grate can likewise be comprehensively reached by the high-pressure water cleaning device, thereby promoting cleaning and also simplifying the holder for the grill grate.

Wherein the high-pressure water cleaning device, in the case of a high-pressure water cleaning device acting on both sides, is arranged or oriented opposite one another or offset relative to one another, or mirrored relative to one another, or arranged or oriented directly opposite one another without offset, cleaning of the grill grate is promoted, since the grill grate is comprehensively reached by the high-pressure water cleaning device.

Wherein the high-pressure water cleaning device is guided via a Cartesian system or comprising a Cartesian system, cleaning of the grill grate can likewise be promoted, since the grill grate is comprehensively reached by the high-pressure water cleaning device and unfavorable or shielding structures of the holder can be avoided by appropriate orientation of the high-pressure water cleaning device.

Wherein the high-pressure water cleaning device is guided via a cable robot system or comprising a cable robot system, guidance and orientation of the high-pressure water cleaning device are promoted.

Wherein the high-pressure water cleaning device comprises at least one spray bar with spray nozzles, cleaning of the grill grate is promoted and accelerated by an enlarged effective area of the high-pressure water cleaning device. In addition, the flexibility of the device with respect to the shapes of the grill grate is increased.

Wherein the high-pressure water cleaning device comprises at least one circulating spray bar with at least one spray nozzle, or at least one circulating or movable or rotating spray nozzle, or at least one circulating or movable spray carriage with at least one spray nozzle, or a rotating spray nozzle, cleaning of the grill grate is promoted and, in addition, the flexibility of the device with respect to the shapes of the grill grate is enhanced.

Wherein the high-pressure water cleaning device comprises at least one stationary or movable spray plate, wherein the spray plate comprises spray nozzles arranged in a distributed manner, cleaning of the grill grate is promoted and accelerated by an enlarged effective area of the high-pressure water cleaning device. This also makes the device more flexible with respect to the shapes of the grill grates.

Wherein the high-pressure water cleaning device comprises a spray lance with at least one spray nozzle, wherein the spray lance is movable between a region remote from the holder for the grill grate and a region of the holder for the grill grate, the spray lance can be removed from a cleaning region in which the holder for the grill grate is located, thereby facilitating a change in position or removal of the grill grate.

Several exemplary embodiments of the invention are illustrated in the drawings. The following is shown:

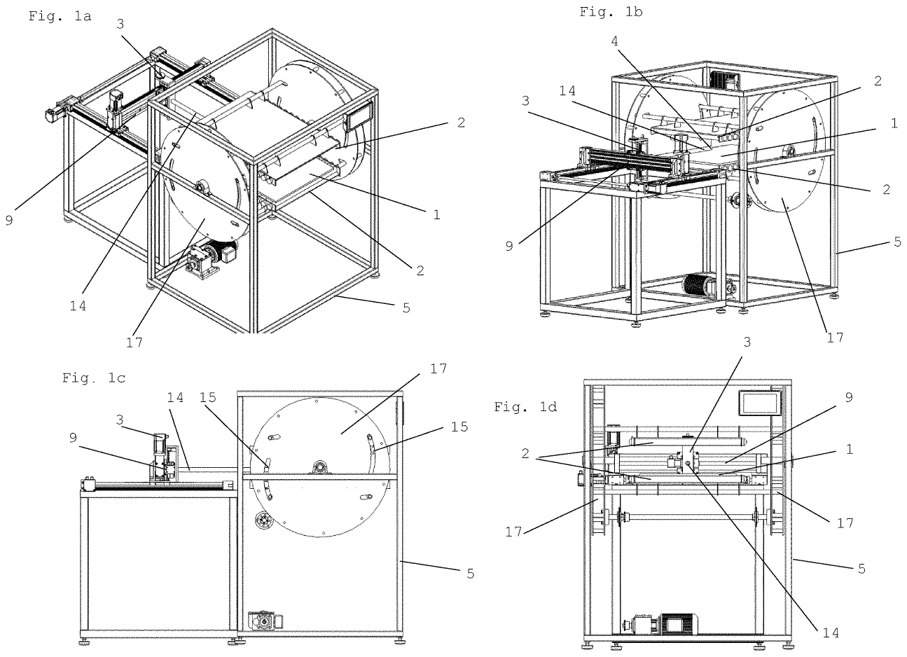

FIG. 1a to 1f a device for cleaning a grill grate with a spray lance and a horizontal, reversible holder for a grill grate,

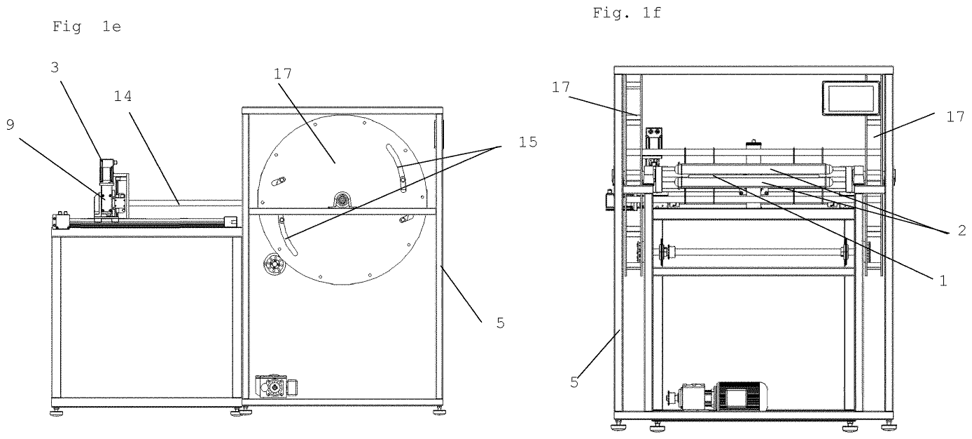

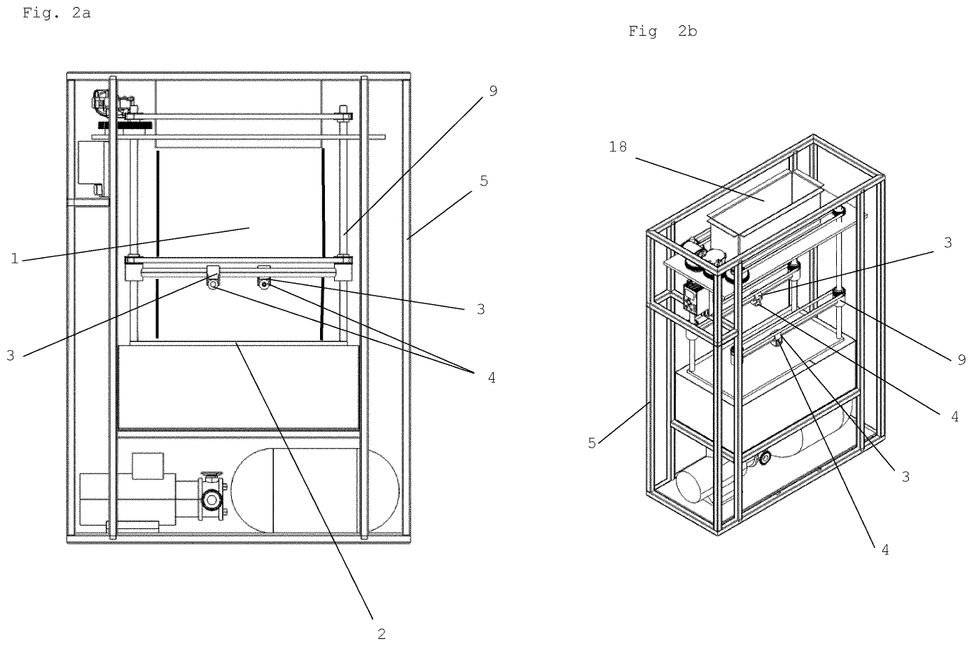

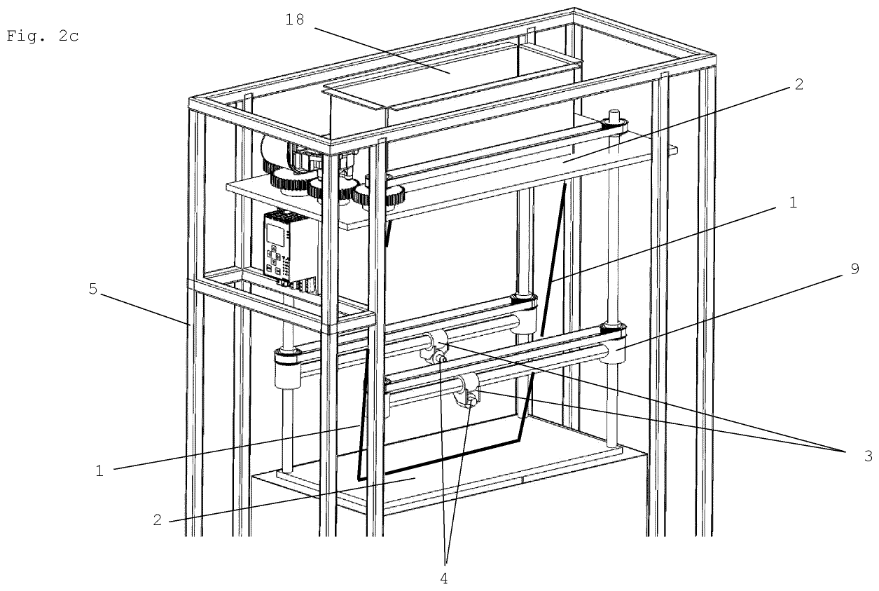

FIG. 2a to 2c a device for cleaning a grill grate, each with a movable spray nozzle on one side of the grill grate and a vertical holder for the grill grate,

FIGS. 3a and 3b a device for cleaning a grill grate with a spray nozzle movable in a Cartesian manner in a lid of a housing with a horizontal holder for a grill grate,

FIG. 4 a device for cleaning a grill grate with a spray nozzle movable horizontally in a Cartesian manner above the grill grate in a lid of a housing and with a horizontal holder for the grill grate, which comprises in each case four horizontally arranged hose-shaped regions above and below the grill grate,

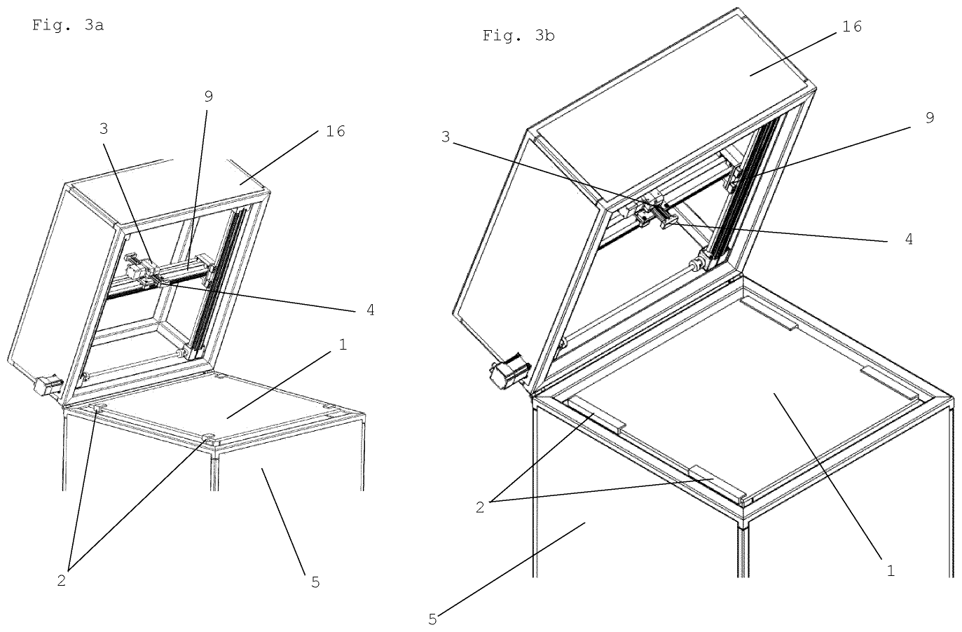

FIG. 5 a device for cleaning a grill grate with a spray nozzle movable horizontally in a Cartesian manner above the grill grate in a lid of a housing in a side view, wherein a horizontal holder for the grill grate has hose-shaped regions above and below the grill grate,

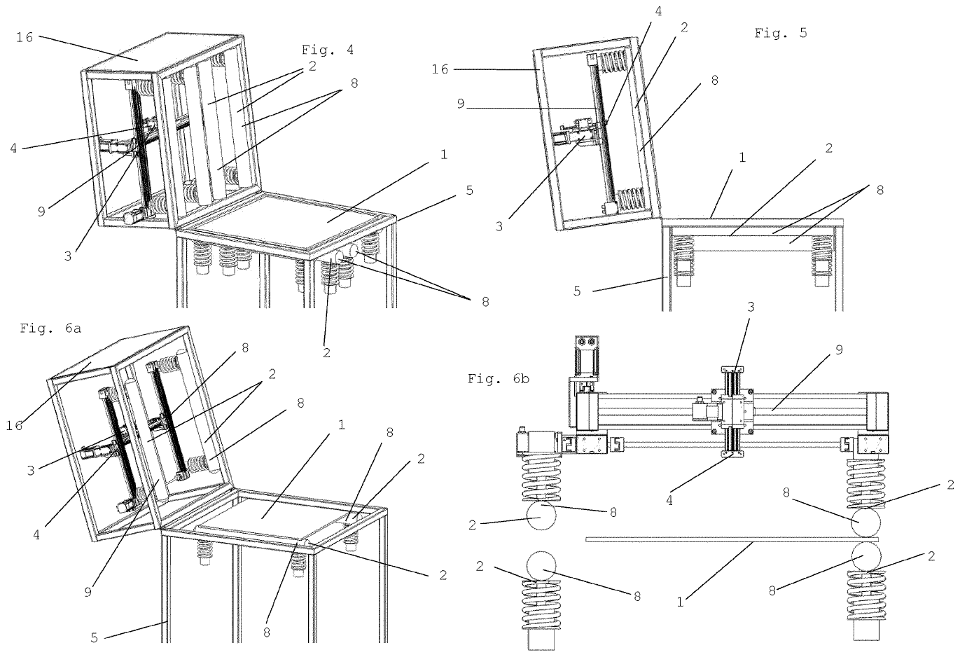

FIGS. 6a and 6b a device for cleaning a grill grate with a spray nozzle movable horizontally in a Cartesian manner above the grill grate in a lid of a housing and with a horizontal holder for the grill grate, which comprises in each case two horizontally arranged hose-shaped regions above and below the grill grate,

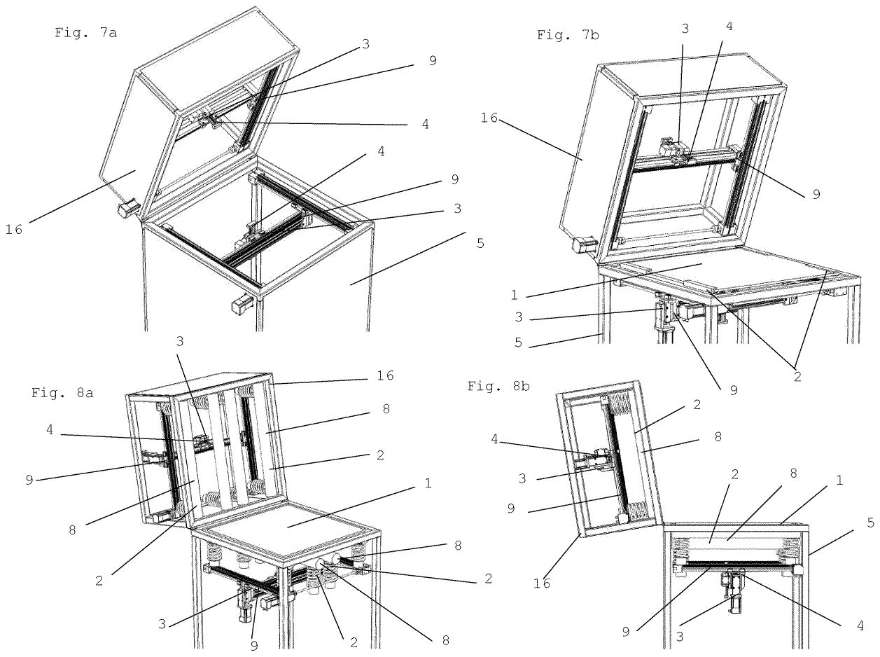

FIGS. 7a and 7b a device for cleaning a grill grate with a spray nozzle movable horizontally in a Cartesian manner above the grill grate in a lid of a housing and below the grill grate, with a horizontal holder for the grill grate,

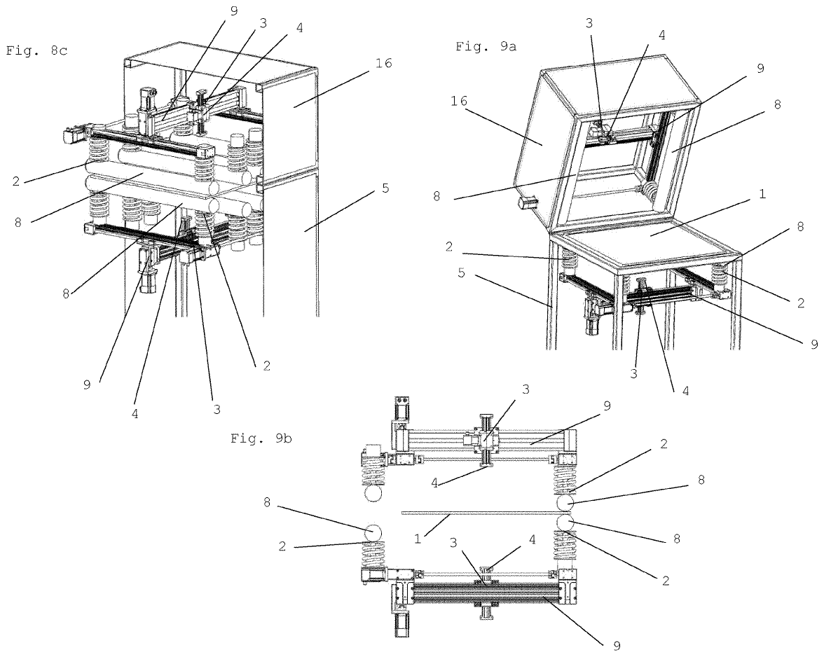

FIG. 8a to 8c a device for cleaning a grill grate with a spray nozzle movable horizontally in a Cartesian manner above the grill grate in a lid of a housing and below the grill grate, with a horizontal holder for the grill grate, which comprises in each case four horizontally arranged hose-shaped regions above and below the grill grate,

FIGS. 9a and 9b a device for cleaning a grill grate with a spray nozzle movable horizontally in a Cartesian manner above the grill grate in a lid of a housing and below the grill grate, with a horizontal holder for the grill grate, which comprises in each case two horizontally arranged hose-shaped regions above and below the grill grate,

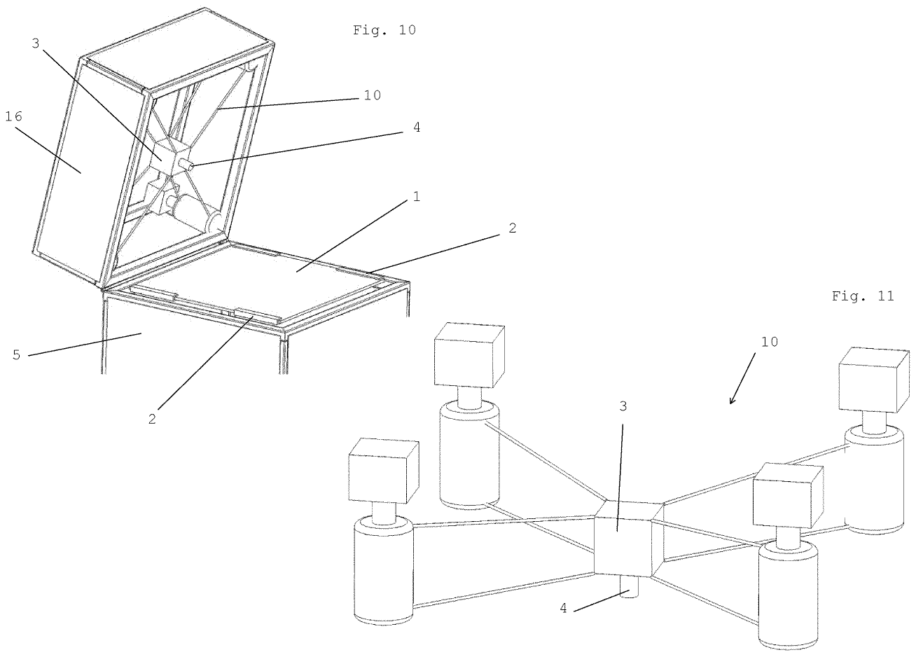

FIG. 10 a device for cleaning a grill grate with a spray nozzle movable or guided above the grill grate by means of a cable robot system in a lid of a housing with a horizontal holder for the grill grate,

FIG. 11 a spray nozzle movable or guided by means of a cable robot system,

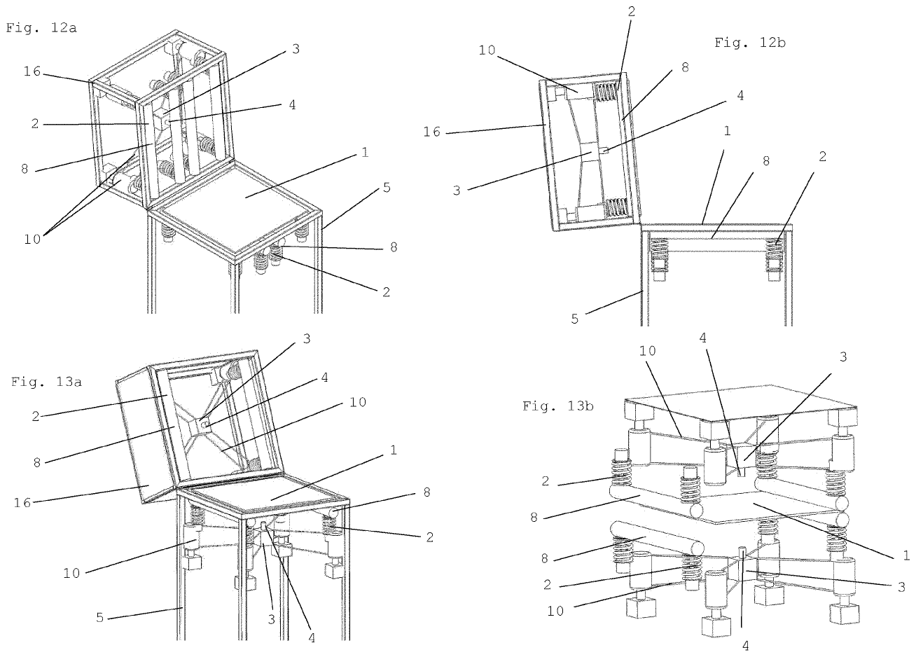

FIGS. 12a and 12b a device for cleaning a grill grate with a spray nozzle movable by means of a cable robot system above the grill grate in a lid of a housing and below the grill grate, with a horizontal holder for the grill grate, which comprises in each case four horizontally arranged hose-shaped regions above and below the grill grate,

FIGS. 13a and 13b a device for cleaning a grill grate with a spray nozzle movable by means of a cable robot system above the grill grate in a lid of a housing and below the grill grate, with a horizontal holder for the grill grate, which comprises in each case two horizontally arranged hose-shaped regions above and below the grill grate,

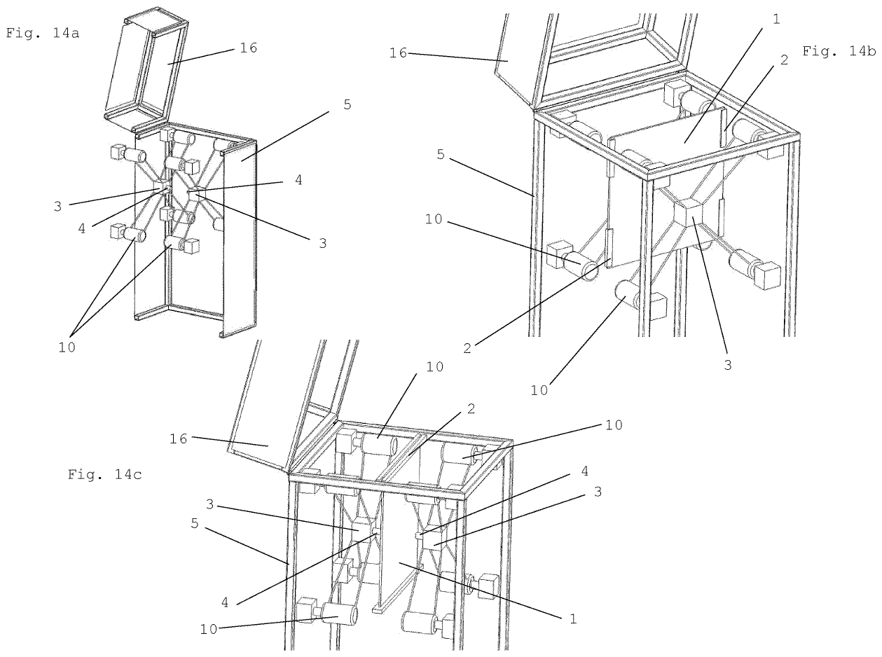

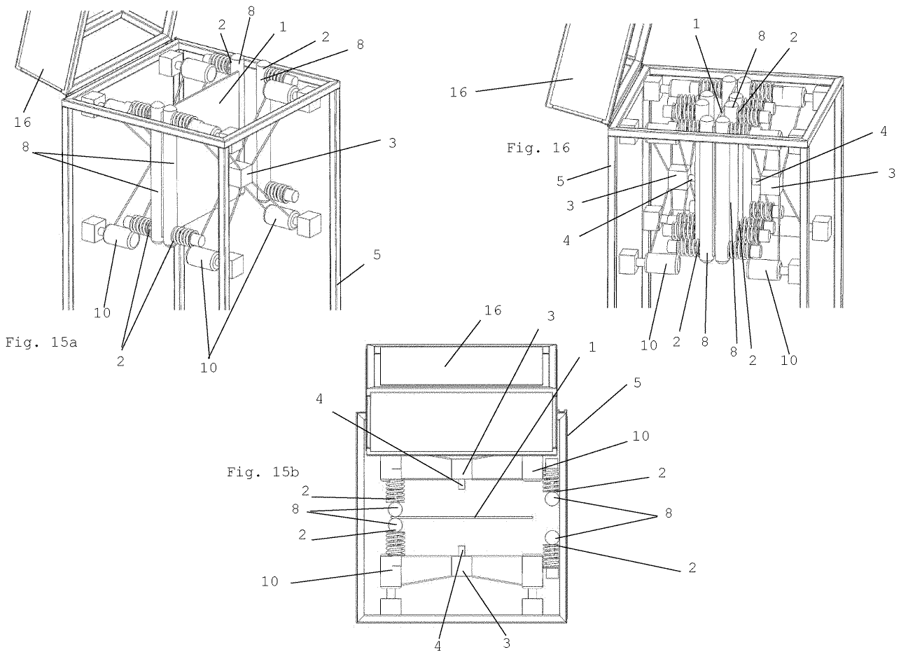

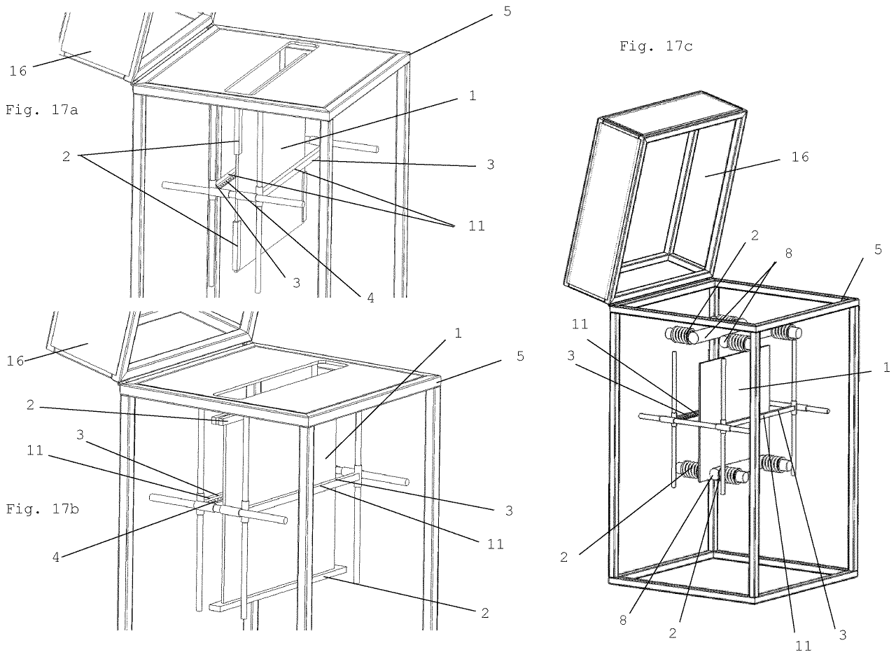

FIG. 14a to 14c a device for cleaning a vertically arranged grill grate with a spray nozzle movable by means of a cable robot system on both sides of the grill grate in a housing and with a vertical holder for the grill grate,

FIGS. 15a and 15b a device for cleaning a vertically arranged grill grate with a spray nozzle movable by means of a cable robot system on both sides of the grill grate in a housing and with a vertical holder for the grill grate, which comprises in each case two horizontally arranged hose-shaped regions on both sides of the grill grate,

FIG. 16 a device for cleaning a vertically arranged grill grate with a spray nozzle movable by means of a cable robot system on both sides of the grill grate in a housing and with a vertical holder for the grill grate, which comprises in each case four horizontally arranged hose-shaped regions on both sides of the grill grate,

FIG. 17a to 17c a device for cleaning a vertically arranged grill grate with a spray bar having spray nozzles that is vertically movable relative to the grill grate in a housing and with holders for the vertical position of the grill grate,

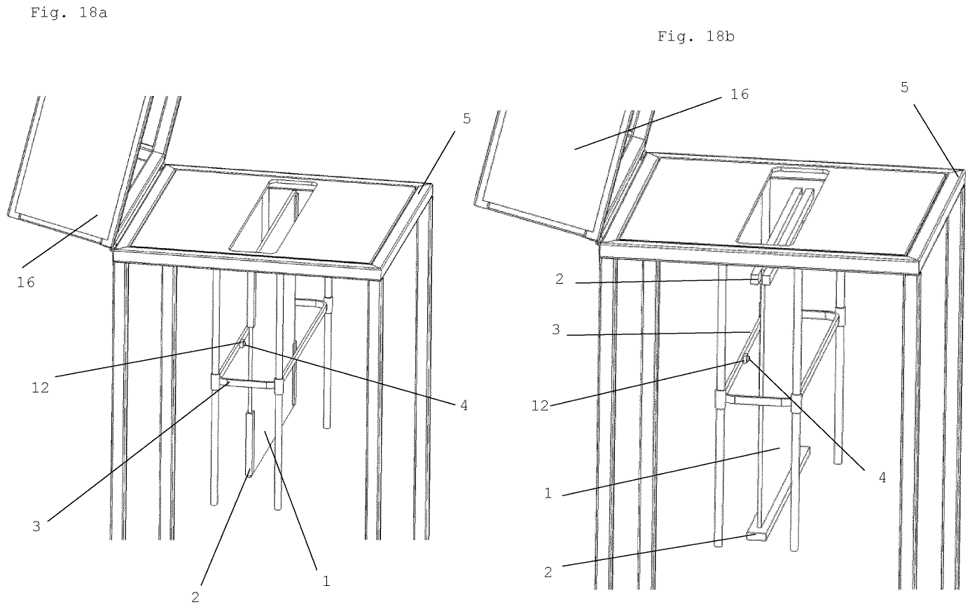

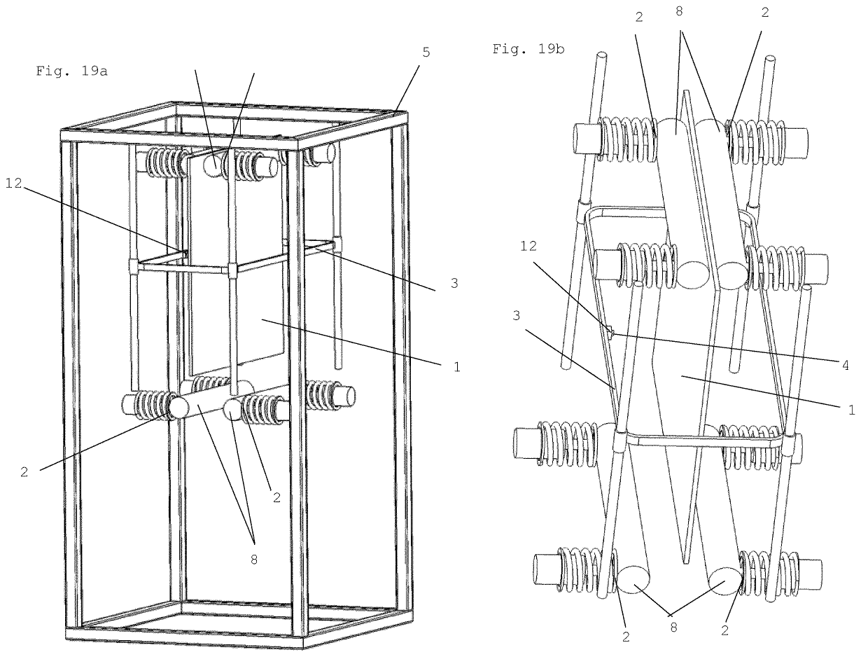

FIGS. 18a and 18b a device for cleaning a vertically arranged grill grate with a spray carriage circulating around the grill grate or movable around the grill grate and also vertically movable, and with a vertical holder for the grill grate,

FIGS. 19a and 19b a device for cleaning a vertically arranged grill grate with a spray carriage circulating around the grill grate or movable around the grill grate and also vertically movable, and with a vertical holder for the grill grate, which comprises in each case two horizontally arranged hose-shaped regions at the upper and lower ends of the grill grate,

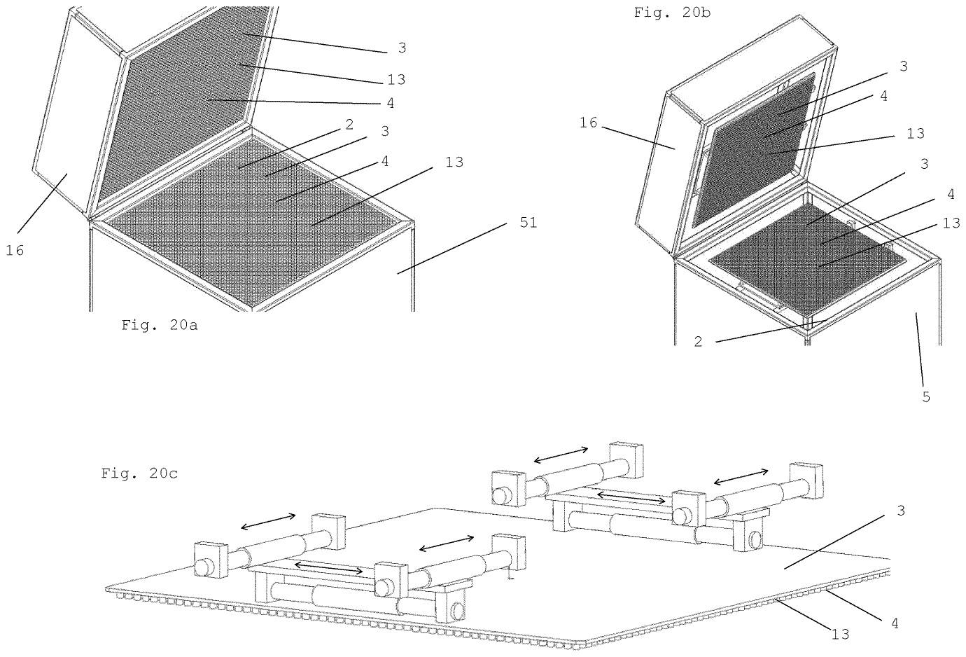

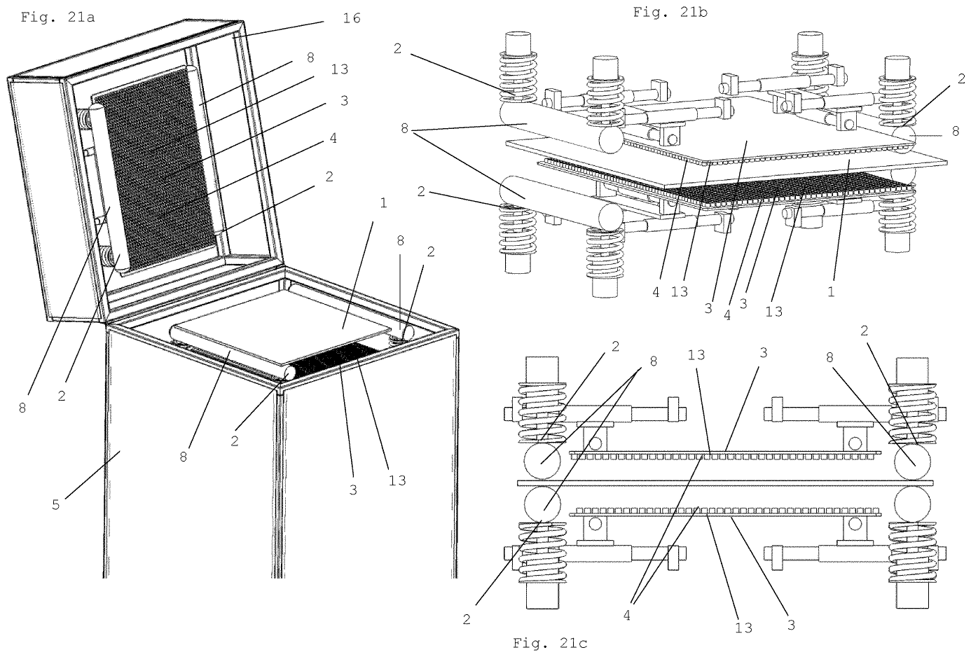

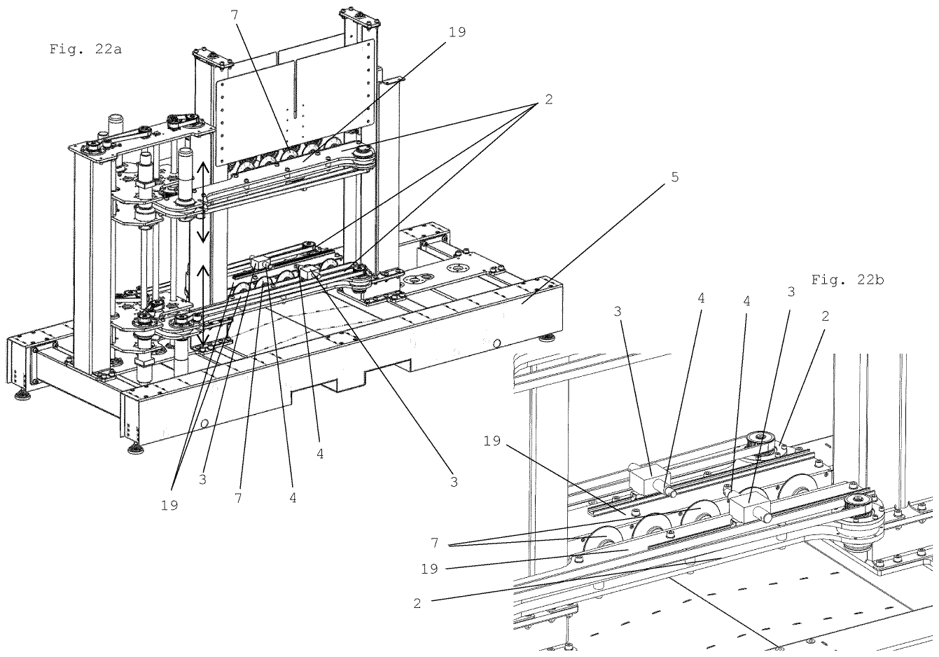

FIG. 20a to 20c a device for cleaning a horizontally arranged grill grate with spray plates arranged on both sides of the grill grate and with a horizontal holder for the grill grate,

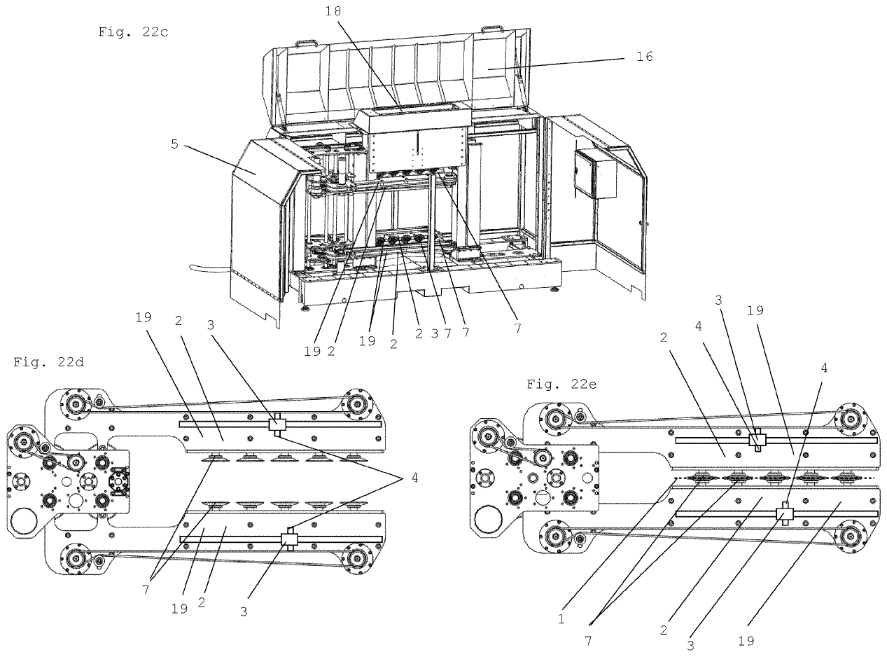

FIG. 21a to 21c a device for cleaning a horizontally arranged grill grate with spray plates arranged on both sides of the grill grate and with a horizontal holder for the grill grate, which comprises in each case two horizontally arranged hose-shaped regions on both sides of the grill grate,

and

FIG. 22a to 22e a device for cleaning a vertically arranged grill grate with movable and displaceable holding arms as the holder, wherein each holding arm comprises a movable spray nozzle.

The device according to the invention, as shown in FIGS. 1a to 1f, for cleaning a grill grate 1, comprises, in the specific exemplary embodiment, a holder 2 for the grill grate 1, into which the grill grate 1 can be slid or placed. The grill grate 1 is arranged horizontally in this case. The grill grate 1 is placed, via an input opening (not shown), onto the lower level of the holder 2, which is equipped with an inflatable hose battery. In the case of one-sided cleaning performed from above, the holder 2 acts on the grill grate 1 from one side, namely from below. In this case, the grill grate rests on the holder 2.

The grill grate 1 can be cleaned only from one side. After cleaning of a first side, it must be turned over.

For turning the grill grate 1, the holder 2 acts on the grill grate 1 from opposite sides or surfaces and holds or clamps it.

The holder 2 is reversible or rotatable. For this purpose, a hose drum 17 or clamping drum 17 is provided. In plates at the axial ends of the hose drum 17 or clamping drum 17, two geometrically defined curved slots 15, as shown in FIGS. 1c and 1e, are provided. These curved slots move the holder 2, which is formed by plates equipped with pneumatically fitted hoses as an inflatable hose battery, as shown in FIG. 1a, relative to one another during a rotational movement of the hose drum 17 or clamping drum 17, as shown in FIG. 1f. As a result, the inserted grill grate 1, or the inserted grill grates 1, are clamped, as shown in FIG. 1f, and can be turned and placed back down on the opposite side. The second side of the grill grate 1 can now be cleaned.

Furthermore, a high-pressure water cleaning device 3 with a spray lance 14 is provided, which comprises at least one spray nozzle 4. The high-pressure water cleaning device 3 is arranged on one side of the grill grate 1 and acts on the grill grate 1 from one side. The spray lance 14 of the high-pressure water cleaning device 3 is guided via a Cartesian system 9.

The respective spray nozzle 4 can also be designed as a rotating spray nozzle 4.

For turning the grill grate 1, the pressure lance designed as a spray lance 14 is movable between a region offset from, that is, outside the region of the holder for the grill grate 1, and a region of the holder 2, that is, in the region of or between the holders 2 for the grill grate 1, as shown in FIGS. 1b, 1c, and 1e.

By means of a pressure lance designed as a spray lance 19, which is driven by an upstream Cartesian system 9, which is therefore arranged upstream of the hose drum 17 or clamping drum 17, the grill grate 1 is cleaned with one or more high-pressure water cleaning jets from at least one spray nozzle 4 at a pressure of, for example, 1000 bar, and the entire surface is digitally controlled and scanned.

The holder 2 for the grill grate 1 and the high-pressure water cleaning device 3 are surrounded by a housing 5, wherein the housing walls are not shown for better clarity. Likewise, the grill grate 1 is shown only as a surface.

A further embodiment of the device according to the invention for cleaning a grill grate 1 is shown in FIGS. 2a to 2c, wherein, in a housing 5, a holder 2 for the grill grate 1 and a high-pressure water cleaning device 3 with at least one spray nozzle 4 are arranged. For better clarity, the housing walls of the housing 5 are not shown. The grill grate 1 can be inserted vertically and arranged at an angle. The grill grate 1 can be slid or inserted from above through an input opening 18 and placed or set down on the lower level of the holder 2, that is, parked at an angle, as shown in FIG. 2c.

The high-pressure water cleaning device 3 comprises one or more spray nozzles 4 per side, as is shown in particular in FIG. 2c, which can be moved via a vertically arranged Cartesian system 9. This Cartesian system 9 is designed in duplicate, that is, a Cartesian system 9 is used on both sides of the grill grate 1, as shown in FIGS. 2b and 2c. Thus, both sides of the grill grate 1 can be cleaned at the same time. The forces acting on the grill grate 1, which are generated by the water jets, are approximately equal on both sides. As a result, a force equilibrium is created, and the grill grate 1 does not move during cleaning. The grill grate 1 is cleaned with one or more high-pressure water cleaning jets, for example at a pressure of 1000 bar, and the entire surface on the left and right sides, that is, on both sides, is digitally controlled and scanned or traversed.

The further embodiment of the device according to the invention for cleaning a grill grate 1 shown in FIGS. 3a and 3b comprises a housing 5 with an openable lid as a housing lid 16, which can be opened. In the housing 5, a holder 2 for the grill grate 1 and a high-pressure water cleaning device 3 with at least one spray nozzle 4 are arranged.

The grill grate 1 is inserted or slid in horizontally into installed guides as the holder 2. The holder 2 is, as shown in FIG. 3a, for example, a clamp-like fastening, or, as shown in FIG. 3b, for example, a rail-like fastening, and in the case of one-sided cleaning performed from above, acts on the grill grate 1 at the lateral edge region or from the edge. In the housing lid 16, a horizontal Cartesian system 9 for the high-pressure water cleaning device 3 with one or more nozzles as spray nozzles 4 is arranged. The one or more spray nozzles 4 can be moved via the Cartesian system 9. The grill grate 1 can be cleaned only from one side, namely from the upper side. After cleaning of a first side, it must be turned over. By means of a display, it is signaled when the cleaning of one side has been completed. When the display, for example in the form of an indicator lamp, switches to green, the openable lid as the housing lid 16 can be opened again and the grate as the grill grate 1 can be turned. Thereafter, the housing lid 16 is closed again, and the second side can be cleaned. The grill grate is cleaned with one or more high-pressure water cleaning jets, for example at a pressure of 1000 bar, and the entire surface is digitally controlled and scanned or traversed.

As an alternative to the holder 2 as a clamp-like fastening or as a rail-like fastening, the holder 2 can also comprise at least one inflatable hose-shaped region 8 as an inflatable hose profile 8.

Thus, as the holder 2, in each case two or in each case four of the hose-shaped regions 8 as hose profiles 8 can be arranged as a group above and below the grill grate 1 as an inflatable hose battery 8.

In FIGS. 4 and 5, a device according to the invention for cleaning a grill grate 1 is shown, in which a high-pressure water cleaning device 3 with at least one spray nozzle 4 is arranged only in the housing lid 16 as an openable lid of a housing 5. As the holder 2, in the housing lid 16 and in the housing 5, in each case four hose-shaped regions 8 as hose profiles 8 are arranged as a group above and below the grill grate 1 as an inflatable hose battery. The four hose-shaped regions 8 as hose profiles 8 are arranged vertically, as shown in FIGS. 4 and 5, and are also movable horizontally, so that the spray nozzle 4 can reliably clean the grill grate 1. The grill grate 1 can be clamped at least between two opposing ones of the respective four hose-shaped regions 8 as the respective hose profile 8 and can also be displaced laterally therebetween.

Advantageously, a portion of the hose-shaped regions 8 can have a protective covering at least in certain regions, so that the spray nozzle does not destroy the hose-shaped region 8 in the region of one of the hose-shaped regions 8.

The devices according to the invention for cleaning a grill grate 1 comprise a housing 5 with an openable lid as a housing lid 16, which can be opened. In the housing 5, a holder 2 for the grill grate 1 and a high-pressure water cleaning device 3 with at least one spray nozzle 4 are arranged.

Furthermore, FIGS. 6a and 6b show a device according to the invention for cleaning a grill grate 1, in which a high-pressure water cleaning device 3 with at least one spray nozzle 4 is arranged only in the housing lid 16 as an openable lid of a housing 5. As the holder 2, in the housing lid 16 and in the housing 5, in each case two hose-shaped regions 8 as hose profiles 8 are arranged as a group opposite one another above and below the grill grate 1 as an inflatable hose battery. The two hose-shaped regions 8 as hose profiles 8 are each movable vertically and also horizontally, as shown in FIG. 6b, so that the spray nozzle 4 can clean the grill grate reliably and without obstruction. As shown in FIG. 6b, the grill grate 1 can be clamped at the edge or in the edge region between two opposing ones of the respective four hose-shaped regions 8 as the respective hose profile 8 and can also be displaced laterally therebetween. At least during a change from one group of two opposing hose-shaped regions 8 as hose profiles 8 to the other group, both groups engage the grill grate 1.

In deviation from the illustrations and exemplary embodiments of FIGS. 3a to 6b, in particular in FIG. 7a as well as in FIGS. 7b to 9b of the devices according to the invention for cleaning a grill grate 1, a high-pressure water cleaning device 3 with in each case at least one spray nozzle 4 is shown as being arranged both in the housing lid 16 as an openable lid of a housing 5 and in the housing 5, that is, in each case above and below the grill grate arranged in the housing. In the housing lid 16 and in the housing 5, a horizontal Cartesian system 9 with one or more nozzles as spray nozzles 4 is arranged for the high-pressure water cleaning device 3. The one or more spray nozzles 4 can be moved via the Cartesian system 9. The grill grate 1 can thus be cleaned from both sides at the same time.

In FIG. 7b, the grill grate 1 can be placed or slid horizontally into installed guides as the holder 2. The holder 2 is, for example, a rail-like fastening and, in the case of one-sided cleaning performed from above, acts on the grill grate 1 at the lateral edge region or from the edge.

In FIGS. 8a to 8c, as the holder 2, in the housing lid 16 and in the housing 5, in each case four hose-shaped regions 8 as hose profiles 8 are arranged as a group above and below the grill grate 1 as an inflatable hose battery. The four hose-shaped regions 8 as hose profiles 8 are each movable vertically and also horizontally, so that the grill grate is reliably cleaned by means of the spray nozzle 4. The grill grate 1 can be clamped at least between two opposing ones of the respective four hose-shaped regions 8 as the respective hose profile 8 and can also be displaced laterally therebetween.

When the housing lid 16 is opened, the grill grate 1 can be placed or inserted onto the installed holder 2 formed by the hose-shaped regions 8 as hose profiles 8 as an inflatable hose battery. The four hose-shaped regions 8 as hose profiles 8 as an inflatable hose battery are equipped, for example, on two plates (not shown) on both sides of the grill grate 1 with in each case four pneumatically fitted or pressurizable hoses. These can be moved relative to one another, in particular in opposing pairs, and thus clamp or fix the grill grate 1. Per level, for example, two left hose-shaped regions 8 as hose profiles 8 are digitally actuated and brought into the clamping position. By moving the hose-shaped regions 8 as hose profiles 8 toward one another, the inserted grill grate 1 can be clamped on one side on the left by the lower and upper levels. The right overhanging portion of the upper and lower sides of the grill grate 1 can be cleaned at the same time, because the spray nozzles 4 as water jet nozzles are arranged above and below. The high-pressure water cleaning device 3 guided via the Cartesian system 9 with at least one spray nozzle 4 is digitally controlled and sweeps or scans the entire, in particular exposed, surface of the grill grate 1 with one or more high-pressure water cleaning jets, for example at a pressure of 1000 bar.

For the other surface region of the grill grate 1, the four hose-shaped regions 8 as hose profiles 8 as an inflatable hose battery on the two plates (not shown) arranged on both sides of the grill grate 1 and equipped with in each case four pneumatically fitted or pressurizable hoses are likewise moved toward one another. Per level, this time the two right hoses are digitally actuated and brought into the clamping position. As a result, by moving the lower and upper levels toward one another, the inserted grill grate 1 is clamped on one side on the right. The left overhanging portion of the upper and lower sides of the grill grate 1 can now be cleaned at the same time, because the spray nozzles 4, as described above, are arranged above and below, that is, above and below the grill grate 1. The high-pressure water cleaning device 3 guided via the Cartesian system 9 with two horizontal axes and one vertical axis and with at least one spray nozzle 4 is digitally controlled and sweeps or scans the entire, in particular exposed, surface of the grill grate 1 with one or more high-pressure water cleaning jets, for example at a pressure of 1000 bar.

As shown as a device according to the invention for cleaning a grill grate 1 in FIGS. 9a and 9b, the grill grate 1, as the holder 2 in the housing lid 16 and in the housing 5, can have in each case two hose-shaped regions 8 as hose profiles 8 as a group above and below the grill grate 1 as an inflatable hose battery. The respective two hose-shaped regions 8 as hose profiles 8 are each movable vertically and also horizontally, so that the grill grate can be reliably cleaned by means of the spray nozzle 4. The grill grate 1 can be clamped at least between two opposing ones of the respective four hose-shaped regions 8 as the respective hose profile 8 and can also be displaced laterally therebetween.

Likewise, when the housing lid 16 is opened, the grill grate 1 can be placed or inserted onto the installed holder 2 formed by the hose-shaped regions 8 as hose profiles 8 as an inflatable hose battery. The respective two hose-shaped regions 8 as hose profiles 8 as an inflatable hose battery are equipped with in each case two pneumatically fitted or pressurizable hoses. These can in each case be moved toward one another in opposing pairs and thus clamp or fix the grill grate 1. Per level, for example, the left and/or right hose-shaped region 8 as hose profile 8 is digitally actuated and brought into the clamping position. By moving the hose-shaped regions 8 as hose profiles 8 toward one another, the inserted grill grate 1 can be clamped on one side on the left and/or right by the lower and upper levels, as shown for the right side in FIG. 9b. The right or, as shown in FIG. 9b, the left overhanging portion of the upper and lower sides of the grill grate 1 can now be cleaned at the same time, because the spray nozzles 4 as water jet nozzles are arranged above and below. The high-pressure water cleaning device 3 guided via the Cartesian system 9 with at least one spray nozzle 4 is digitally controlled and sweeps or scans the entire, in particular exposed, surface of the grill grate 1 with one or more high-pressure water cleaning jets, for example at a pressure of 1000 bar.

In the exemplary embodiments according to FIGS. 10 to 16, in the devices according to the invention for cleaning a grill grate 1, the high-pressure water cleaning device 3 is guided via at least one cable robot system 10, as shown by way of example in FIG. 11. Furthermore, the device according to the invention for cleaning a grill grate 1 comprises a housing 5 with an openable lid as a housing lid 16. In the housing 5, a holder 2 for the grill grate 1 and the high-pressure water cleaning device 3 with at least one spray nozzle 4 are arranged. The respective spray nozzle 4 can also be designed as a rotating spray nozzle 4.

As shown in FIGS. 12a and 12b, a high-pressure water cleaning device 3 is guided via a cable robot system 10 only in the housing lid 16 and is thus arranged horizontally during operation. Accordingly, only one-sided cleaning of the grill grate is provided, and the grill grate must be turned over for cleaning of the second side.

In FIGS. 13a and 13b, a high-pressure water cleaning device 3 is arranged in the housing lid 16 and a high-pressure water cleaning device 3 is arranged in the housing 5. Thus, both sides of the grill grate can be cleaned simultaneously or at least without turning. In this example as well, the cable robot systems 10 are arranged horizontally during operation.

The holders 2 are, as described above with respect to FIGS. 3a and 3b, for example provided as a rail-like fastening, as shown in FIG. 10.

Furthermore, holders with hose-shaped regions 8 as hose profiles 8, as described above with respect to FIGS. 8a to 9b, are also used, as shown in FIGS. 12a to 13b and 15a to 16.

According to FIGS. 12a and 12b, as the holder 2 in the housing lid 16 and in the housing 5, in each case two hose-shaped regions 8 as hose profiles 8, as shown in FIGS. 13a and 13b, or four hose-shaped regions 8 as hose profiles 8, as shown in FIGS. 12a and 12b, are arranged as a group above and below the grill grate 1 as an inflatable hose battery. Two or four hose-shaped regions 8 as hose profiles 8 are each movable vertically, as shown in FIGS. 12b and 13b, and also horizontally, as shown in FIG. 13b, so that the grill grate can be reliably cleaned by means of the spray nozzle 4. The grill grate 1 can be clamped at least between two opposing ones of the respective two or four hose-shaped regions 8 as the respective hose profile 8 and can also be displaced laterally therebetween.

As described above, when the lid as the housing lid 16 is opened, the grill grate can be placed onto the installed guides. The hose-shaped regions 8 as hose profiles 8 are arranged as a group, for example on two plates (not shown), on both sides of the grill grate 1 and are equipped with, as shown in FIGS. 12a and 12b, four, or as shown in FIGS. 13a and in particular 13b, two pneumatically fitted hoses, and are moved toward one another in opposing pairs in order to clamp the grill grate 1. Per level, the left or right two opposing hoses or, as shown in FIGS. 13a and in particular 13b, the respective two opposing hoses are digitally actuated and brought into the clamping position. Thus, by moving the lower and upper levels toward one another, the inserted grill grate 1 is clamped on one side on the left or right. The corresponding right or left overhanging portion of the grill grate can, as shown in FIGS. 12a and 12b, be cleaned only from above, whereas, as shown in FIGS. 13a and 13b, the upper and lower sides of the grill grate 1 are cleaned simultaneously, since the water jet nozzles as spray nozzles 4 of the high-pressure water cleaning device 3 are arranged above and below via the cable robot system 10 with two horizontal axes and one vertical axis. By means of the spray nozzles 4, the respective surface can be digitally scanned with one or more high-pressure water cleaning jets, for example at a pressure of 1000 bar.

Further embodiments of the devices according to the invention for cleaning a grill grate 1 according to FIGS. 14a to 16 provide that two high-pressure water cleaning devices 3 are present, each of which has a vertically arranged cable robot system 10, between which the grill grate 1 is arranged or can be arranged. In addition, a holder 2 for the vertical fixation of the grill grate 1 is provided. Accordingly, the lid as the housing lid 16 can also be opened here, and the grill grate 1 can be placed onto or between the vertically installed guides.

The holder 2 can, as described above, be, for example, a rail-like fastening and acts, as shown in FIGS. 14b and 14c, on the grill grate 1 at the lateral edge region or at the edge region at the top and bottom or from the edge.

Furthermore, as likewise described above, hose-shaped regions 8 as hose profiles 8 can also be used as a group of hydraulically or pneumatically pressurized hoses, which, like the cable robot systems 10 of the high-pressure water cleaning devices 3, are arranged vertically. Thus, on each side of the grill grate 1, as shown in FIGS. 15a and 15b, two, or as shown in FIG. 16, four hose-shaped regions 8 as hose profiles 8 are present as a group of hydraulically or pneumatically pressurized hoses and can be moved toward one another in opposing pairs in order to clamp the grill grate 1. Per level, as shown in FIGS. 15a and 15b, the respective left or right opposing hoses or, as shown in FIG. 16, the respective two left or right opposing hoses are digitally actuated and brought into the clamping position, and the inserted grill grate 1 is clamped on one side on the left or right. The corresponding right or left overhanging portion of the grill grate 1 can, as shown in FIGS. 15a and 15b, be cleaned simultaneously on both sides, since the water jet nozzles as spray nozzles 4 of the high-pressure water cleaning device 3 are arranged laterally via the cable robot system 10 with two vertical axes and one horizontal axis. By means of the spray nozzles 4, the respective surface can be digitally scanned with one or more high-pressure water cleaning jets, for example at a pressure of 1000 bar.

Further embodiments of the device according to the invention for cleaning a grill grate 1 according to FIGS. 17a to 17c provide that a high-pressure water cleaning device 3 is present which has two vertically movable spray bars 11 with spray nozzles 4, between which the grill grate 1 is likewise arranged or can be arranged vertically and by means of which the grill grate 1 can be cleaned on both sides.

In addition, a holder 2 for the vertical fixation of the grill grate 1 is provided, which, as described above, is, for example, a rail-like fastening and, as shown in FIGS. 17a and 17b, holds the grill grate 1 at the lateral edge region or at the edge region at the top and bottom or from the edge.

Furthermore, as likewise described above, hose-shaped regions 8 as hose profiles 8 can also be used as a group of hydraulically or pneumatically pressurized hoses which, as shown in FIG. 17c, are arranged horizontally in the upper and lower regions of the vertical grill grate 1. Thus, on each side of the grill grate 1, two horizontally arranged hose-shaped regions 8 as hose profiles 8 are present as a group of hydraulically or pneumatically pressurized hoses and can be moved toward one another in opposing pairs in the horizontal direction and/or displaced vertically in order to clamp the grill grate 1. In accordance with the area to be cleaned, the respective upper or lower opposing hoses are digitally actuated and brought into the clamping position, and the inserted grill grate 1 is correspondingly clamped in the upper or lower region. The corresponding lower or upper overhanging portion of the grill grate 1 can be cleaned simultaneously on both sides, since the water jet nozzles as spray nozzles 4 of the spray bar 11 of the high-pressure water cleaning device 3 are movable vertically along the grill grate 1. By means of the spray nozzles 4, the respective surface can be digitally scanned with multiple high-pressure water cleaning jets, for example at a pressure of 1000 bar.

Furthermore, here as well, the lid as the housing lid 16 can be opened accordingly, and the grill grate 1 can be placed onto or between the vertically or vertically superposed installed guides.

Alternatively, in a device according to the invention for cleaning a grill grate 1, not shown, two vertical plates equipped with four pneumatically fitted hoses as respective inflatable hose-shaped regions 8 as inflatable hose profiles 8 are provided. These are moved toward one another. Per vertical level, the left or right two hoses are digitally actuated and brought into the clamping position. As a result, the vertical levels on the left and right are moved toward one another, and the vertically inserted grill grate 1 is clamped on one side on the left or right. The right or left overhanging portion of the left and right sides of the grill grate 1 can be cleaned simultaneously, because the water jet nozzles as spray nozzles 4 are arranged on the left and right. The two vertically movable spray bars 11, equipped with spray nozzles 4 for high-pressure water cleaning jets, for example at a pressure of 1000 bar, clean the free overhanging vertical surface of the grill grate 1.

In further embodiments of the device according to the invention for cleaning a grill grate 1 according to FIGS. 18a and 18b as well as 19a and 19b, in deviation from the embodiments according to FIGS. 17a and 17b as well as 17c, instead of the vertically movable spray bar 11, a high-pressure water cleaning device 3 with a circulating or movable spray nozzle 4 or at least one circulating or movable spray carriage 12 with at least one spray nozzle 4 is used, the circulating path of which is additionally vertically movable. As a result, the grill grate 1 can be cleaned circumferentially on all sides. The respective spray nozzle 4 can also be designed as a rotating spray nozzle 4.

For a more detailed description of the respective holder 2 with respect to the embodiment according to FIGS. 18a and 18b, reference is made to the description of the embodiments relating to FIGS. 17a and 17b, and for a more detailed description of the respective holder 2 with respect to the embodiment according to FIGS. 19a and 19b, reference is made to the description of the embodiment of FIG. 17c.

Furthermore, here as well, the lid as the housing lid 16 can be opened accordingly, and the grill grate 1 can be placed onto or between the vertically or vertically superposed installed guides.

As an alternative thereto, in a device according to the invention for cleaning a grill grate 1, not shown, two vertical plates equipped with four pneumatically fitted hoses as respective inflatable hose-shaped regions 8 as inflatable hose profiles 8 are provided. These can be moved toward one another. Per vertical level, the left two hoses are digitally actuated and brought into the clamping position. As a result, the vertical levels on the left and right are moved toward one another, and the vertically inserted grill grate is clamped on one side on the left or right. The right or left overhanging portion of the left and right sides of the grill grate can be cleaned simultaneously, because the water jet nozzles are arranged on a spray bar circulating on the left. A spray bar 11, movable vertically on the left or right side and circulating horizontally, as a spray carriage 12 of the high-pressure water cleaning device 3, equipped with water jet nozzles as spray nozzles 4 for high-pressure water cleaning jets, for example at a pressure of 1000 bar, cleans the free overhanging vertical surface.

Further embodiments of the device according to the invention for cleaning a grill grate 1 according to FIGS. 20a to 21c provide that a high-pressure water cleaning device 3 is present which has a spray plate 13, wherein the spray plate 13 comprises spray nozzles 4 arranged in a distributed manner, between which the grill grate 1 is arranged or can be arranged horizontally and by means of which the grill grate 1 can be cleaned on both sides.

According to the embodiment shown in FIG. 20a, a spray plate 13 is arranged as a high-pressure water cleaning device 3 in the housing lid 16 and a spray plate 13 is arranged in the housing 5. The grill grate 1 can be placed or inserted onto the spray plate 13 in the housing 5, which at the same time functions as the holder 2. For cleaning, the housing lid 16 can be closed, and cleaning is carried out by means of the spray plates 13 in the housing lid 16 and in the housing 5 and the spray nozzles 4 present therein for high-pressure water cleaning jets, for example at a pressure of 1000 bar.

Advantageously, the spray plate 13 is movable in the horizontal direction, as shown in FIG. 20b and in particular in FIG. 20c. Accordingly, in the embodiment according to FIG. 20b, the grill grate 1 can be placed or inserted onto the housing 5. For cleaning with the housing lid 16 closed, the spray plate 13 in the housing lid 16 and in the housing 5 is movable in the horizontal direction and thus reaches the entire surface of the grill grate 1.

The further embodiment of the device according to the invention for cleaning a grill grate 1 provides, according to FIGS. 21a to 21c, a spray plate 13 movable in the horizontal direction with spray nozzles 4 arranged in a distributed manner as the high-pressure water cleaning device 3 in the housing lid 16 and in the housing 5, wherein hose-shaped regions 8 as hose profiles 8 are provided as the holder 2. It is provided that in each case two hose-shaped regions 8 as hose profiles 8 in the housing lid 16 and two hose-shaped regions 8 as hose profiles 8 in the housing 5 are arranged laterally and parallel to the spray plate 13 and are arranged to be movable vertically and horizontally. The hose-shaped regions 8 as hose profiles 8 are hydraulically or pneumatically pressurizable hoses. Accordingly, on each side of the grill grate 1, two horizontally arranged hose-shaped regions 8 as hose profiles 8 are present as a group of hydraulically or pneumatically pressurizable hoses and can be moved toward one another in opposing pairs in the vertical direction and/or displaced vertically in order to clamp the grill grate 1. In accordance with the area to be cleaned, the respective upper or lower opposing hoses are digitally actuated and brought into the clamping position, as shown in FIG. 21b, and the inserted grill grate 1 is correspondingly clamped in the lateral region. The unused hose-shaped regions 8 as hose profiles 8 can be displaced out of the cleaning region, as likewise shown in FIG. 21b. During a side change between the hose-shaped regions 8 as hose profiles 8, all hose-shaped regions 8 as hose profiles 8 clamp the grill grate 1 for a moment, as shown in FIG. 21c.

The corresponding laterally overhanging portion of the grill grate 1 can be cleaned simultaneously on both sides by means of the movable spray plate 13, since the water jet nozzles as spray nozzles 4 of the spray plate 13 of the high-pressure water cleaning device 3 are directed vertically onto the grill grate 1. By means of the spray nozzles 4, the respective surface can be digitally scanned with multiple high-pressure water cleaning jets, for example at a pressure of 1000 bar.

Furthermore, here as well, the lid as the housing lid 16 can be opened accordingly, and the grill grate 1 can be placed onto or between the vertically or vertically superposed installed guides.

Alternatively, in a device according to the invention for cleaning a grill grate 1 that is not shown, two horizontal plates equipped with four pneumatically fitted hoses as respective inflatable hose-shaped regions 8 as inflatable hose profiles 8 are provided. These can be moved toward one another. Per horizontal level, the left or right two hoses are digitally actuated and brought into the clamping position on the grill grate 1. In this process, the horizontal level on the left and right is moved toward one another, and the horizontally inserted grill grate is clamped on one side on the left or right. The right or left overhanging portion of the left and right sides of the grill grate 1 can in each case be cleaned on both sides, that is, from above and below at the same time, because the many stationary water jet nozzles as spray nozzles 4 are arranged on a respective spray plate 13 above and below the grill grate 1. A large number of spray nozzles 4 in or on the spray plate 13 provide high-pressure water cleaning jets, for example at a pressure of 1000 bar, for cleaning the free right or left overhanging horizontal surface on both sides.

A further embodiment of the device according to the invention for cleaning a grill grate 1 is shown in FIGS. 22a to 22e. In this case, the grill grate 1 is or is arranged vertically. The device provides a holder 2 for the grill grate 1 and a high-pressure water cleaning device 3 with at least one spray nozzle 4. The holder 2 for the grill grate 1 and the high-pressure water cleaning device 3 are surrounded by a housing 5, as shown in FIG. 22c. The device comprises, as shown in FIG. 22c, an input opening 18, into which the grill grate 1 can be slid or placed into the housing and/or the holder 2. The holder 2 comprises four holding arms 19, wherein plate-shaped, cup-shaped, or suction-cup-shaped holding elements 7 are arranged on each of the holding arms 19. In each case two holding arms 19 are arranged adjacent to one another at the same height and spaced parallel to one another. The holding elements 7 on the holding arms 19 are arranged opposite one another and facing one another on the respective holding arms 19.

The holding arms 19 arranged adjacent to one another at the same height and spaced parallel to one another as the holder 2 can be pivoted parallel and transverse to the grill grate 1 from an open position into a closed position holding the grill grate, as shown in FIGS. 22d and 22e. The holding elements 7 are arranged on the holding arms 19 in such a manner that, in the holding position of the holding arms 19, the holding elements 7 act on the grill grate 1 from opposite surfaces and hold and clamp the grill grate 1, as shown in FIG. 22e.

Furthermore, the holding arms 19 as the holder can, in pairs, alone and/or together with the grill grate 1, be vertically displaceable or movable as required, as shown in FIG. 22a.

A high-pressure water cleaning device 3 with a horizontally movable spray nozzle 4 is provided on each of the holding arms 19. The spray nozzle 4 can also be arranged in a movable spray carriage 12.

It is provided that initially the pair of the upper or lower two holding arms 19 arranged adjacent to one another at the same height holds the grill grate 1 in the closed position. The other two corresponding lower or upper holding arms 19 arranged adjacent to one another at the same height are in an open position, in which vertical movement of the holding arms 19 is possible. In addition to the vertical movement of the holding arms 19, the horizontally movable spray nozzles 4 on the holding arms 19 move in the open position. The movable spray nozzles 4 or the movable spray carriages 12 can in each case be driven by means of a toothed belt, as shown in FIG. 22b.

By means of the spray nozzles, high-pressure water cleaning jets, for example at a pressure of 1000 bar, can be provided for cleaning the free surface of the grill grate 1 on both sides.

Thus, the high-pressure water cleaning device 3 is movable horizontally and vertically and over at least one region of the planar extent of the grill grate 1. In addition, the high-pressure water cleaning device 3 is arranged on both sides of the grill grate 1, wherein the high-pressure water cleaning device 3 acts on or is oriented toward the grill grate 1 on one side or on both sides.

The high-pressure water cleaning devices 3 can, in the case of a high-pressure water cleaning device 3 acting on both sides, be arranged or oriented opposite one another or offset relative to one another. Likewise, the high-pressure water cleaning devices 3 can be arranged or oriented mirrored relative to one another or directly opposite one another without offset.

It is alternatively also provided that the respective high-pressure water cleaning device 3 comprises a spray bar 11 with spray nozzles 4, which is vertically movable together with the respective holding arm 19 of the holder 2 and over at least one region of the planar extent of the grill grate 1. The respective spray nozzle 4 can also be designed as a rotating spray nozzle 4.

### LIST OF REFERENCE SIGNS

1—Grill grate
2—Holder
3—High-pressure water cleaning device
4—Spray nozzle
5—Housing
6—Pressure elements
7—Holding elements
8—Hose-shaped region
9—Cartesian system
10—Cable robot system
11—Spray bar
12—Spray carriage
13—Spray plate
14—Spray lance
15—Curved slot
16—Housing lid
17—Hose drum, clamping drum
18—Input opening
19—Holding arm

1. A device for Cleaning a Grill Grate, comprising:
a holder for the grill grate and a high-pressure water cleaning device with at least one spray nozzle, wherein the grill grate can be arranged vertically, at an incline, or horizontally, and wherein at least the holder for the grill grate and the high-pressure water cleaning device are surrounded by a housing.

2. The device according to claim 1, wherein the holder comprises a tray, tray areas, a shaft, or at least one support surface and/or that the grill grate can be slid into, inserted into, or placed into the holder.

3. The device according claim 1, wherein the holder holds and clamps the grill grate at at least one edge and/or at at least one edge region.

4. The device according to claim 1, wherein the holder holds and clamps the grill grate at at least two opposite end faces or outer edge surfaces.

5. The device according to claim 1, wherein the holder acts on the grill grate from one side or from opposite sides or surfaces or edges, or holds and clamps the grill grate.

6. The device according to claim 1, wherein the holder is arranged parallel and/or transverse to the grill grate and/or that the grill grate is displaceable or movable together with the holder.

7. The device according to claim 1, wherein the holder comprises air-actuatable or fluid-actuatable pressure elements or holding elements and/or that the holder comprises a region having a longitudinal extension and/or a hose-shaped region, wherein the region having the longitudinal extension and/or the hose-shaped region is arranged vertically or horizontally.

8. The device according to claim 7, wherein at least the hose-shaped region comprises a protective covering at least in certain regions.

9. The device according to claim 1, wherein the holder is pivotable, reversible, rotatable, or movable.

10. The device according to claim 1, wherein the holder comprises plate-shaped, cup-shaped, or suction-cup-shaped holding elements and/or at least one holding arm.

11. The device according to claim 1, wherein the high-pressure water cleaning device is movable horizontally and/or vertically and/or over at least a portion of the surface area of the grill grate.

12. The device according to claim 1, wherein the high-pressure water cleaning device is arranged on one side or on both sides of the grill grate, wherein the high-pressure water cleaning device acts on or is aligned with the grill grate on one side or on both sides.

13. The device according to claim 1, wherein in the case of a high-pressure water cleaning device acting on both sides, the high-pressure water cleaning device is arranged or aligned opposite one another or offset relative to one another, or mirrored relative to one another, or arranged or aligned directly opposite one another without offset.

14. The device according to claim 1, wherein the high-pressure water cleaning device is guided by a Cartesian system or comprises a Cartesian system.

15. The device according to claim 1, wherein the high-pressure water cleaning device is guided by a cable robot system or comprises a cable robot system.

16. The device according to claim 1, wherein the high-pressure water cleaning device comprises at least one spray bar with spray nozzles.

17. The device according to claim 1, wherein the high-pressure water cleaning device comprises at least one circulating spray bar with at least one spray nozzle, or at least one circulating, movable, or rotating spray nozzle, or at least one circulating or movable spray carriage with at least one spray nozzle, or a rotating spray nozzle.

18. The device according to claim 1, wherein the high-pressure water cleaning device comprises at least one stationary or displaceable spray plate, wherein the spray plate comprises spray nozzles arranged in a distributed manner.

19. The device according to claim 1, wherein the high-pressure water cleaning device comprises a spray lance with at least one spray nozzle, wherein the spray lance is movable between a region spaced apart from the holder for the grill grate and a region of the holder for the grill grate.
